(19) United States
(12) Patent Application Publication
(10) Pub. No.: US 2025/0380127 A1
(43) Pub. Date: Dec. 11, 2025

(54) SYSTEM, METHOD, AND COMPUTER PROGRAM FOR TRANSFERRING A USER SUBSCRIPTION BETWEEN SMARTPHONES FROM DIFFERENT OEMS

(71) Applicant: Amdocs Development Limited, Limassol (CY)

(72) Inventor: Nadav Kremer, Hadera (IL)

(21) Appl. No.: 18/739,120

(22) Filed: Jun. 10, 2024

(51) Int. Cl. H04W 8/20; H04W 8/22

(52) U.S. Cl. CPC H04W 8/20; H04W 8/22

(57) ABSTRACT

As described herein, a system, method, and computer program are provided for transferring a user subscription between mobile devices of different OEMs. A request to transfer a subscription to a carrier service of a service provider from a first mobile device having a first operating system to a second mobile device having a second operating system is received. A flow for transferring the subscription from the first mobile device having the first operating system to the second mobile device having the second operating system is performed.

### FIELD OF THE INVENTION

The present invention relates to transfer of user subscriptions between mobile devices.

### BACKGROUND

Today where many smartphones are manufactured with a digital eSIM only, there is a challenge of moving an existing user subscription from an old plastic SIM device to a new smartphone with the digital eSIM.

While many Original Equipment Manufacturers (OEMs) such as Apple, Google, Samsung, etc. have proprietary solutions for their own brand, there is no existing industry standard for transferring a user subscription between smartphones from different OEMs who use different operating systems.

There is thus a need for addressing these and/or other issues associated with the prior art. For example, there is a need to transfer a user subscription between mobile devices of different OEMs.

### SUMMARY

As described herein, a system, method, and computer program are provided for transferring a user subscription between mobile devices of different OEMs. A request to transfer a subscription to a carrier service of a service provider from a first mobile device having a first operating system to a second mobile device having a second operating system is received. A flow for transferring the subscription from the first mobile device having the first operating system to the second mobile device having the second operating system is performed.

### BRIEF DESCRIPTION OF THE DRAWINGS

FIG. 1 illustrates a method for transferring a user subscription between mobile devices of different OEMs, in accordance with one embodiment.

FIG. 2 illustrates a system for transferring a user subscription between mobile devices of different OEMs, in accordance with one embodiment.

FIGS. 3A-C illustrates a communication flow diagram among components of the system of FIG. 2, in accordance with one embodiment.

FIG. 4 illustrates a network architecture, in accordance with one possible embodiment.

FIG. 5 illustrates an exemplary system, in accordance with one embodiment.

### DETAILED DESCRIPTION

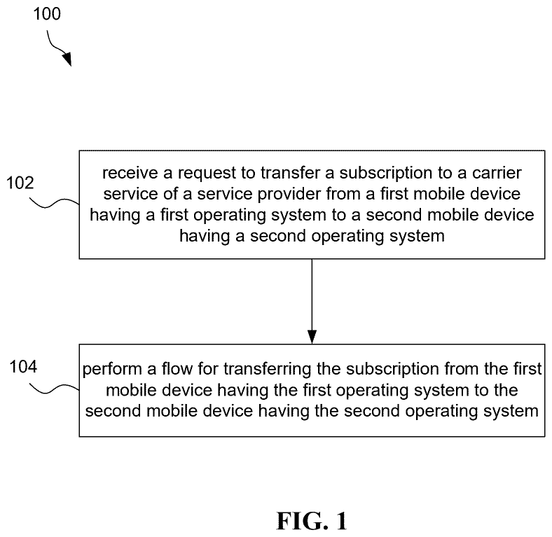

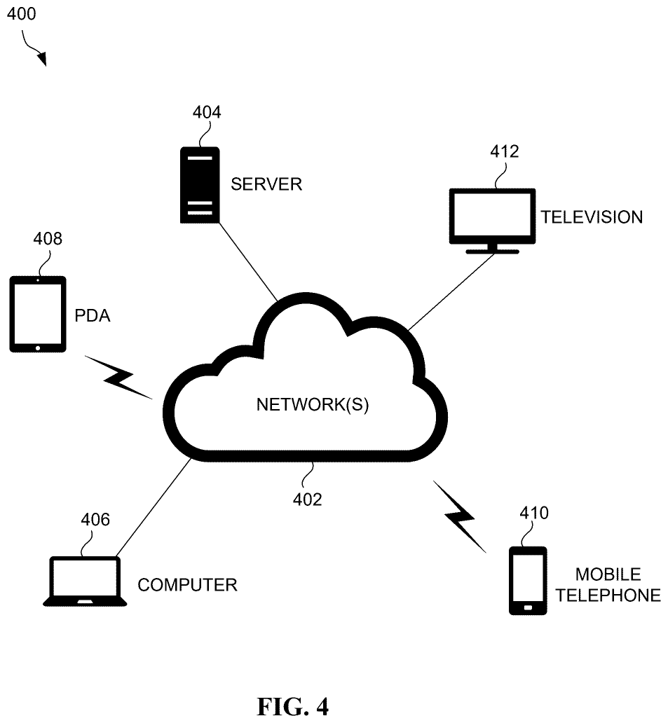

FIG. 1 illustrates a method 100 for transferring a user subscription between mobile devices of different OEMs, in accordance with one embodiment. The method may be carried out by a computer system, such as that described below with respect to FIGS. 4 and/or 5. In an embodiment, the method 100 is carried out by a third party to the mobile devices and to a service provider. In an embodiment, the method 100 is carried out by an entitlement server of the third party. In an embodiment, the entitlement server of the third party is used by the service provider that provides the user subscription.

In operation 102, a request to transfer a subscription to a carrier service of a service provider from a first mobile device having a first operating system to a second mobile device having a second operating system is received. The service provider refers to a communication service provider (CSP) which operates a network over which mobile devices can communicate with one another. The carrier service refers to a communication service of the service provider.

Users can subscribe their mobile device(s) to the carrier service to enable the mobile devices to connect to and communicate over the network via the carrier service. Accordingly, the subscription refers to an existing subscription of the first mobile device to the carrier service. As mentioned, a request to transfer that subscription from the first mobile device to a second mobile device is received. The first mobile device may be a mobile device previously used by the user to communicate over the network, while the second mobile device may be a mobile device newly purchased or otherwise acquired by the user with the intent to use the same to communicate over the network.

Generally, the first and second mobile devices refer to mobile devices configured to be able to connect to and communicate over the carrier service. As noted above, the first and second mobile devices have different operating systems, and accordingly may be provided by different Original Equipment Manufacturers (OEMs). In an embodiment, the first mobile device and the second mobile device may be smartphones. Further, both the first mobile device and the second mobile device may have respective digital Subscriber Identity Modules (eSIMs). In this context, transferring the subscription may include transferring the subscription from the eSIM of the first mobile device to the eSIM of the second mobile device.

In an embodiment, the request may be initiated at the second mobile device. In an embodiment, the request may be initiated by a user of the second mobile device. In an embodiment, the request is initiated via an initial flow performed on the second mobile device that includes the user inputting the user's Mobile Station International Subscriber Directory Number (MSISDN), the user inputting an identifier of the service provider, the second mobile device connecting to its Original Equipment Manufacturer (OEM) cloud to obtain configuration data and a uniform resource locator (URL) of an entitlement server of the third party that is dedicated to the service provider, validating the URL, presenting to the user an option to transfer the subscription to the second mobile device, and initiating the request in response to a user selection of the option. In an embodiment, the request may include an identifier of the third party, a MSISDN, and an identifier of the carrier service. As noted above, the request may be received from the second mobile device by an entitlement server of the third party.

In operation 104, a flow for transferring the subscription from the first mobile device having the first operating system to a second mobile device having the second operating system is performed. As noted above, the flow for transferring the subscription may be performed by the entitlement server of the third party. In an embodiment, the entitlement server of the third party may be used by the service provider.

In an embodiment, the flow of the third party for transferring the subscription from the first mobile device having the first operating system to the second mobile device having the second operating system may include sending a one-time password (OTP) request to the service provider, where the OTP request causes the service provider to send an OTP to the first mobile device, and receiving an OTP response from the service provider indicating that the OTP was sent to the first mobile device. In an embodiment, the flow may further include verifying entry of the OTP on the first mobile device by communicating with the service provider. In an embodiment, the flow may include causing the second mobile device to present to the user an option to reconfirm the transfer of the subscription to the second mobile device, and receiving from the second mobile device an indication of a selection by the user of the option to reconfirm the transfer of the subscription to the second mobile device. In an embodiment, the flow may include after receiving reconfirmation of transfer of the subscription to the second mobile device, providing a profile activation code to the second mobile device, where the second mobile device uses the profile activation code to download from a Subscription Manager Data Preparation (SMDP) device a profile associated with the subscription.

In an embodiment, the third party may monitor the downloading of the profile by communicating with the SMDP device. In an embodiment, the carrier service may be enabled on the second mobile device after the profile is downloaded to the second mobile device. Enabling the carrier service on the second mobile device may allow the second mobile device to connect to and communicate over the network. In an embodiment, a request from the second mobile device for a new token may be received (e.g. the entitlement server of the third party). In an embodiment, a new token may be assigned to the third party for use by the second mobile device.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

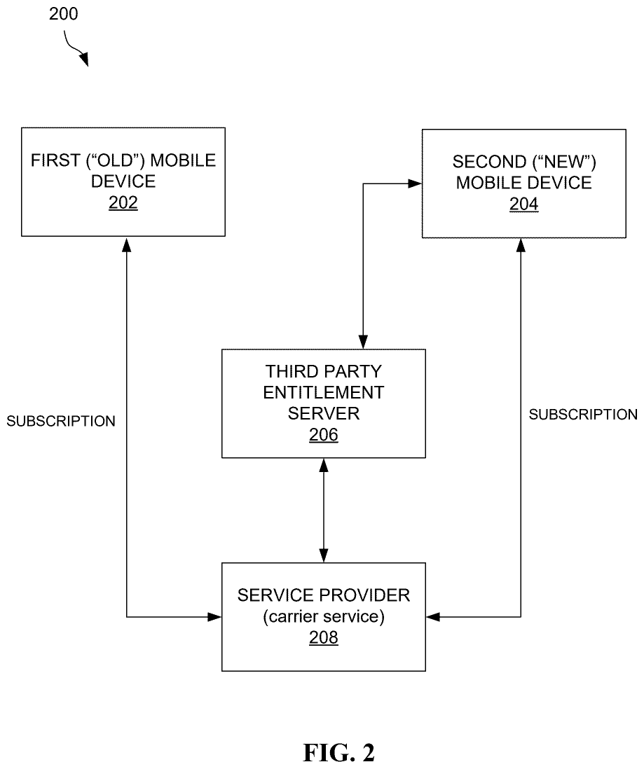

FIG. 2 illustrates a system 200 for transferring a user subscription between mobile devices of different OEMs, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below.

As shown, a first (“old”) mobile device 202 has a subscription to a carrier service of a service provider 208. When a request is received by a third party entitlement server 206 from a second (“new”) mobile device 204 to transfer the subscription from the first mobile device 202 to the second mobile device 204, the third party entitlement server 206 communicates with the service provider 208 to perform a flow to cause the subscription to be transferred as requested.

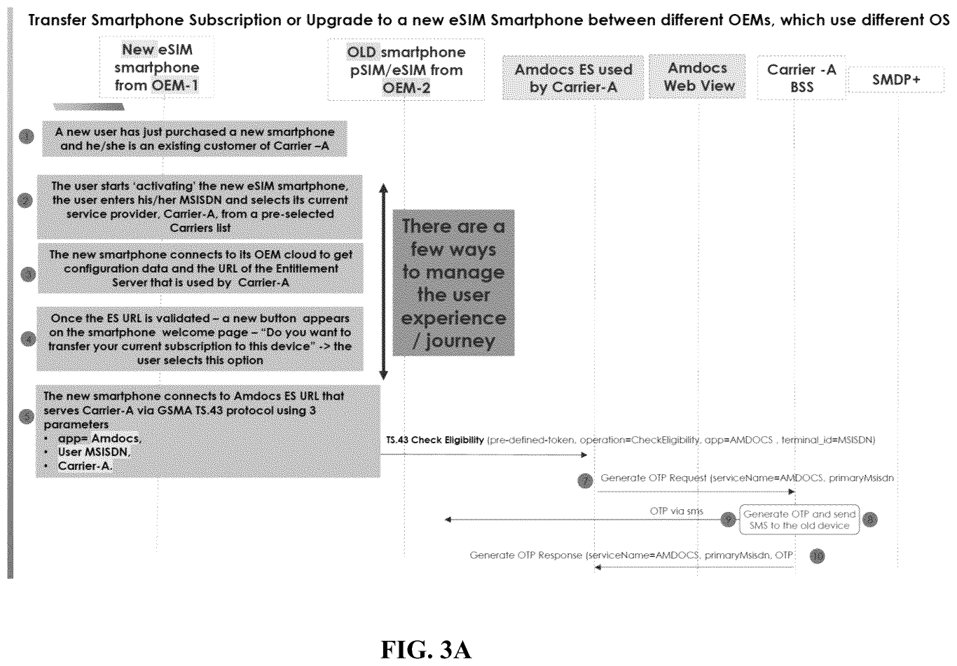

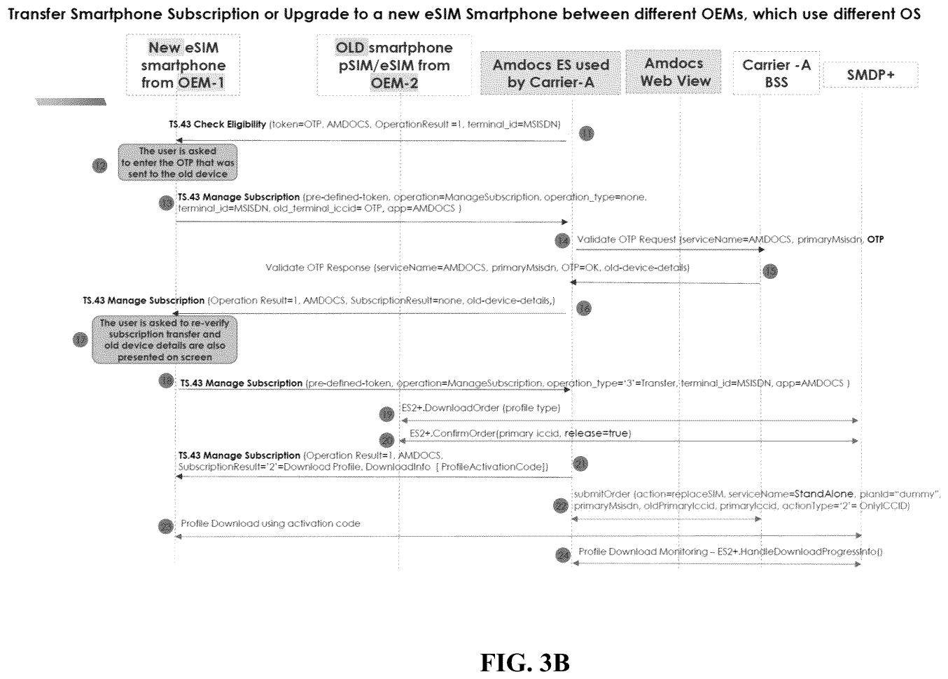

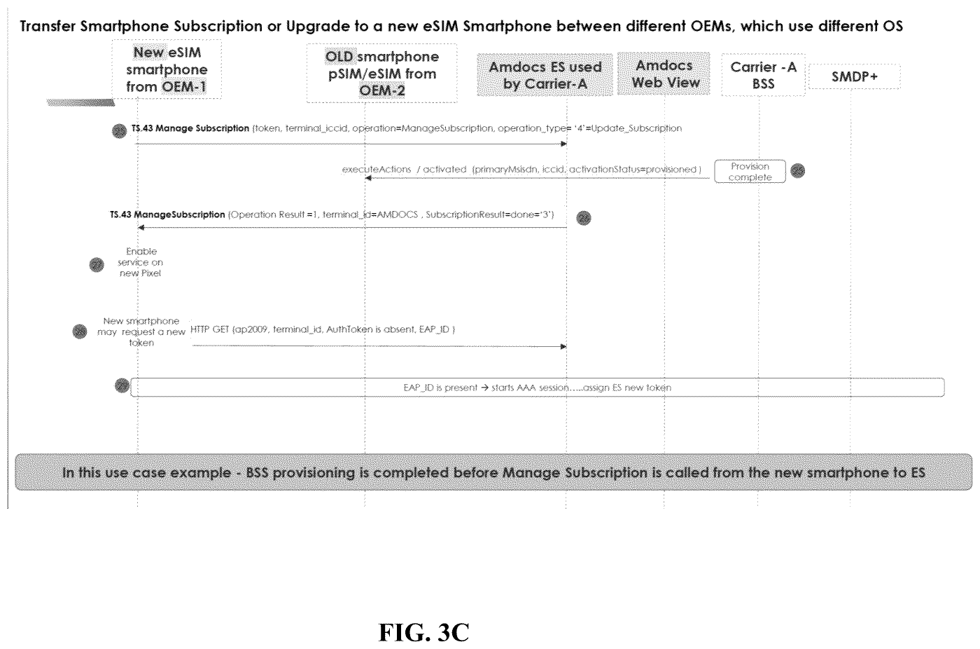

FIGS. 3A-C illustrates a communication flow diagram among components of the system 200 of FIG. 2, in accordance with one embodiment. It should be noted that while the present communication flow references the Global System for Mobile Communications (GSMA) standard for various communications, the present embodiments are not limited thereto.

At step (1), a user purchases or otherwise obtains a new smartphone having an eSIM. The user is an existing customer of the service provider (Carrier-A). At step (2), the user starts activating the new smartphone by entering the user's MSISDN and selecting the service provider from a list of servicer providers.

At step (3), the new smartphone connects to its OEM cloud to get configuration data and a URL of an entitlement server operated by a third party (Amdocs) but used by the service provider. At step (4), the URL is validated at the new smartphone and an option is presented on the new smartphone screen asking if the user wants to transfer an existing subscription to the new smartphone. In the present embodiment, the existing subscription is stored in an eSIM of an old smartphone of the user. In the present communication flow, the user selects the option. At step (5), the new smartphone connects to the third party entitlement server via the URL using parameters including an identifier of the third party, an identifier of the MSISDN, and an identifier of the service provider. The present communication flow shows by way of example that this connection may be made using the GSMA TS.43 protocol for a service entitlement configuration.

At step (6), a check eligibility request is sent to the third party entitlement server. At step (7), the third party entitlement server generates an OTP request and sends the same to the service provider. At step (8), the service provider generates the OTP. At step (9), the service provider sends the OTP to the old smartphone, via short message service (SMS) for example.

At step (10), an OTP response is sent from the service provider to the third party entitlement server. At step (11), the third party entitlement server sends a check eligibility message to the new smartphone. At step (12), the new smartphone requests the user to input the OTP that was sent to the old smartphone. At step (13), a manage subscription message having the OTP is sent from the new smartphone to the third party entitlement server.

At step (14), the third party entitlement server validates the OTP with the service provider. At step (15), the service provider communicates an OTP validation response to the third party entitlement server. At step (16), the third party entitlement server communicates a manage subscription message to the new smartphone.

At step (17), the new smartphone requests the user to reconfirm that the subscription is to be transferred from the old smartphone to the new smartphone. At step (18) when the user provides the reconfirmation, the new smartphone communicates a manage subscription message to the third party entitlement server indicating to perform the transfer of the subscription. At step (19), a profile download order is communicated between the third party entitlement server and an SMDP device, and at step (20) a confirm order is communicated between the third party entitlement server and the SMDP device. At step (21), the third party entitlement server communicates a manage subscription message to the new smartphone with a profile activation code.

At step (22), the third party entitlement server and the service provider communicate an order submission for the eSIM of the new smartphone. At step (23) the new smartphone downloads the profile associated with the subscription from the SMDP using the activation code. At step (24), the third party entitlement server monitors the downloading of the profile to the new smartphone.

At a first step (25), the new smartphone sends a manage subscription message to the third party entitlement server to update the subscription. At a second step (25), the service provider communicates to the old smartphone that the transfer of the subscription to the new smartphone is complete. At step (26) the third party entitlement server communicates a manage subscription message to the new smartphone indicating that the subscription update is complete. At step (27), the carrier service is enabled on the new smartphone. At step (28), the new smartphone requests a new token from the third party entitlement server. At step (29), a flow is performed to assign a new third party entitlement server token to the new smartphone.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

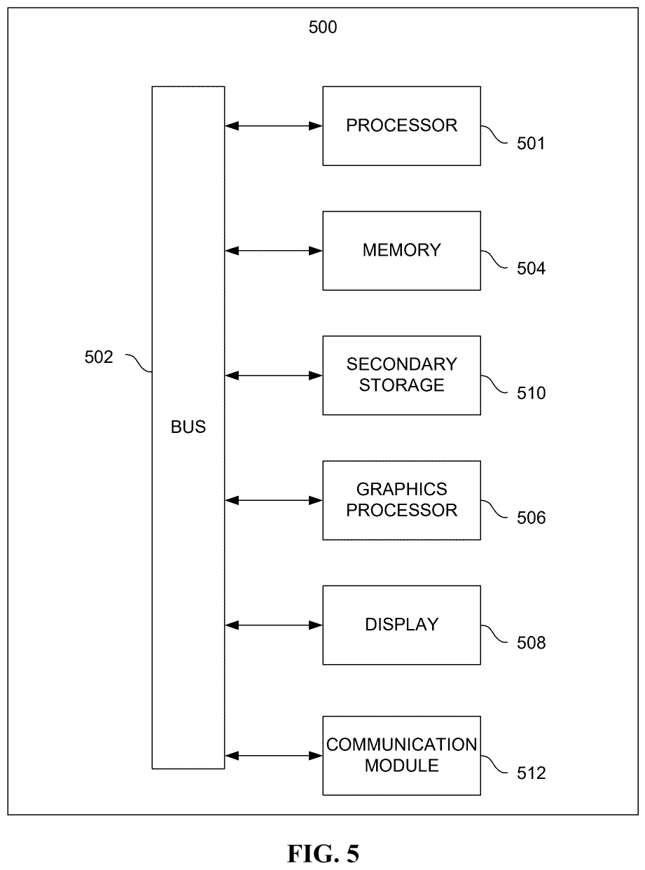

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
receive, by a third party, a request to transfer a subscription to a carrier service of a service provider from a first mobile device having a first operating system to a second mobile device having a second operating system;
perform, by the third party, a flow for transferring the subscription from the first mobile device having the first operating system to the second mobile device having the second operating system.

2. The non-transitory computer-readable media of claim 1, wherein the request is initiated at the second mobile device.

3. The non-transitory computer-readable media of claim 2, wherein the request is initiated by a user of the second mobile device.

4. The non-transitory computer-readable media of claim 3, wherein the request is initiated via an initial flow performed on the second mobile device that includes:
the user inputting the user's Mobile Station International Subscriber Directory Number (MSISDN),
the user inputting an identifier of the service provider,
the second mobile device connecting to its Original Equipment Manufacturer (OEM) cloud to obtain configuration data and a uniform resource locator (URL) of an entitlement server of the third party that is dedicated to the service provider,
validating the URL,
presenting to the user an option to transfer the subscription to the second mobile device, and
initiating the request in response to a user selection of the option.

5. The non-transitory computer-readable media of claim 1, wherein the request is received from the second mobile device by an entitlement server of the third party.

6. The non-transitory computer-readable media of claim 5, wherein the flow for transferring the subscription is performed by the entitlement server of the third party.

7. The non-transitory computer-readable media of claim 5, wherein the entitlement server of the third party is used by the service provider.

8. The non-transitory computer-readable media of claim 1, wherein the request includes an identifier of the third party, a MSISDN, and an identifier of the carrier service.

9. The non-transitory computer-readable media of claim 1, wherein the flow of the third party for transferring the subscription from the first mobile device having the first operating system to the second mobile device having the second operating system includes:
sending a one-time password (OTP) request to the service provider,
wherein the OTP request causes the service provider to send an OTP to the first mobile device, and
receiving an OTP response from the service provider indicating that the OTP was sent to the first mobile device.

10. The non-transitory computer-readable media of claim 9, wherein the flow of the third party for transferring the subscription from the first mobile device having the first operating system to the second mobile device having the second operating system further includes:
verifying entry of the OTP on the first mobile device by communicating with the service provider.

11. The non-transitory computer-readable media of claim 10, wherein the flow of the third party for transferring the subscription from the first mobile device having the first operating system to the second mobile device having the second operating system further includes:
causing the second mobile device to present to the user an option to reconfirm the transfer of the subscription to the second mobile device, and
receiving from the second mobile device an indication of a selection by the user of the option to reconfirm the transfer of the subscription to the second mobile device.

12. The non-transitory computer-readable media of claim 11, wherein the flow of the third party for transferring the subscription from the first mobile device having the first operating system to the second mobile device having the second operating system further includes:
after receiving reconfirmation of transfer of the subscription to the second mobile device, providing a profile activation code to the second mobile device,
wherein the second mobile device uses the profile activation code to download from a Subscription Manager Data Preparation (SMDP) device a profile associated with the subscription.

13. The non-transitory computer-readable media of claim 12, wherein the third party monitors the downloading of the profile by communicating with the SMDP device.

14. The non-transitory computer-readable media of claim 12, wherein the carrier service is enabled on the second mobile device after the profile is downloaded to the second mobile device.

15. The non-transitory computer-readable media of claim 14, wherein the device is further caused to:
receive by the third party a request from the second mobile device for a new token.

16. The non-transitory computer-readable media of claim 15, wherein a new token is assigned to the third party for use by the second mobile device.

17. The non-transitory computer-readable media of claim 1, wherein the first mobile device and the second mobile device are smartphones.

18. The non-transitory computer-readable media of claim 1, wherein the first mobile device has a first digital Subscriber Identity Module (eSIM) and the second mobile device has a second eSIM and wherein the subscription is transferred from the first eSIM to the second eSIM.

19. A method, comprising:
at a computer system:
receiving, by a third party, a request to transfer a subscription to a carrier service of a service provider from a first mobile device having a first operating system to a second mobile device having a second operating system;
performing, by the third party, a flow for transferring the subscription from the first mobile device having the first operating system to the second mobile device having the second operating system.

20. A system, comprising:
a non-transitory memory storing instructions; and
one or more processors in communication with the non-transitory memory that execute the instructions to:
receive, by a third party, a request to transfer a subscription to a carrier service of a service provider from a first mobile device having a first operating system to a second mobile device having a second operating system;
perform, by the third party, a flow for transferring the subscription from the first mobile device having the first operating system to the second mobile device having the second operating system.
